(19) United States
(12) Patent Application Publication
(10) Pub. No.: US 2008/0259338 A1
(43) Pub. Date: Oct. 23, 2008

(54) Carbonate Scale Detector

(75) Inventors: Justin Sanchez, Albuquerque, NM (US); Rodney E. Herrington, Albuquerque, NM (US); Michael C. Armijo, Albuquerque, NM (US)

Correspondence Address: PEACOCK MYERS, P.C., 201 THIRD STREET, N.W., SUITE 1340, ALBUQUERQUE, NM, 87102, US

(73) Assignee: MIOX Corporation, Albuquerque, NM (US)

(21) Appl. No.: 12/052,681

(22) Filed: Mar. 20, 2008

Related U.S. Application Data
(60) Provisional application No. 60/896,685, filed on Mar. 23, 2007.

(51) Int. Cl. G01N 21/59

(52) U.S. Cl. 356/432

(57) ABSTRACT

An apparatus and method for detecting carbonate scale. An energy emitting device transmits energy through one optical window, through a fluid stream, and out through a second optical window where the energy is detected by an energy receiving device. As scale, such as that due to carbonate present in the fluid, accumulates on the wetted surface of the optical windows, the transmission of the energy through the optical windows is obscured. The optical windows may optionally be coated and electrically charged to promote the formation of carbonate scale on the wetted surface of the window. The optical windows can be cleaned by reversing their polarity. By correlating the rate of energy intensity reduction to carbonate scale formation, the concentration of carbonate in the fluid stream can be determined. The carbonate detector can be used to alarm, shutdown, or control operation of equipment that may be adversely affected by the presence of carbonate in the fluid stream. Alternatively the present invention can detect scale formation on an electrode or other electrolytic cell component by analyzing light reflected from that component.

### CROSS-REFERENCE TO RELATED APPLICATIONS

This application claims priority to and the benefit of filing of U.S. Provisional Patent Application Ser. No. 60/896,685, entitled “Carbonate Scale Detector”, filed on Mar. 23, 2007, which is incorporated herein by reference.

### FIELD OF THE INVENTION

This invention relates to a method and device for measuring the presence of carbonate scale in a fluid stream.

### BACKGROUND OF THE INVENTION

Electrolytic cells are used in a variety of applications to generate oxidants for use in disinfection. Electrolytic technologies have been developed to produce mixed-oxidants and sodium hypochlorite solutions from a sodium chloride brine solution. U.S. Pat. No. 4,761,208 by Gram, et al. describes an electrolytic method and cell for sterilizing water. These electrolytic cells typically have a source water feed stream and a brine feed stream. The feed water can typically be softened to remove carbonate from the water stream, and softened water can also be used to generate the brine solution. However, salt for making brine often contains calcium as a contaminant in the salt. Due to the concentration of the brine, the brine can not be softened using ion exchange resin.

Operating conditions within the cell are ideal for the formation of scale deposits on electrode plates. For instance, calcium carbonate scale can build up on the cathode electrode of a chlorine producing electrolytic brine cell. Carbonate scale can electrically blind the cathode causing localized current density increases in the opposing dimensionally stable anode (DSA), which can cause passivation failure of the DSA coating. This failure mode can cause rapid destruction of the electrolytic cell.

By measuring the formation of carbonate in the oxidant fluid stream exiting the electrolytic cell, the electrolytic cell operation can be alarmed or terminated. This will allow maintenance to be timely performed on the electrolytic cell to repair the effects of the carbonate scale before destruction of the electrolytic cell occurs. The present invention can also be used to detect carbonate formation in any aqueous fluid where carbonate formation is considered a contaminant in the system. Examples include boiler water systems, distilling systems, ion exchange water softening to indicate that resin regeneration is required, membrane softening systems, dialysis systems, commercial sodium hypochlorite pumping and piping systems, and any other applications where a contaminant attracted to a material in a high pH environment can be detected.

### SUMMARY OF THE INVENTION

The present invention is an apparatus to detect scale formation in a fluid stream. The apparatus comprises a flow-through chamber for the fluid stream; at least two optical windows, at least one of the optical windows accumulating scale formation from the fluid stream; an energy emitting device transmitting an energy beam through both the optical windows and the fluid stream; and an energy receiving device measuring the intensity of the energy beam. The energy emitting device preferably comprises an infrared LED, and the energy receiving device preferably comprises an infrared phototransistor. The optical windows preferably comprise quartz or synthetic sapphire.

The apparatus preferably further comprises a control system for receiving a signal from the energy receiving device, wherein the signal is preferably correlated to the intensity, which is preferably related to the amount of the scale formation. The control system is preferably activated when the intensity reaches a level indicating a predetermined amount of scale formation. The rate of change of the signal preferably determines a concentration of carbonate in the fluid stream. The control system preferably comprises a circuit for quantifying the level of scale in the fluid stream, and preferably comprises an adjustable control mechanism providing adjustment for detection sensitivity. The control system further preferably comprises a switch for transmitting a signal to an external device, and preferably comprises a device such as an alarm, electrolytic cell controller, ion exchange controller, or reversible power supply. The electrolytic cell controller preferably deactivates a power supply for an electrolytic cell and initiates a cleaning cycle. The ion exchange controller preferably initiates regeneration of ion exchange resin.

The present invention is preferably used to detect and control scale formation in electrolytic cell applications and is useful for detecting carbonate scale formation, controlling regeneration cycles in ion exchange resin systems, and detecting and controlling scale formation in a system where scale formation is detrimental to system operation. Such a system includes but is not limited to an electrolytic chlorine cell, an electrolytic device, a boiler water system, a distiller, a water softening system, or a membrane system.

Each of the optical windows of the present invention preferably comprises a coating, which preferably comprises at least one property of, including but not limited to, electrically conductive, optically transparent, chemically resistant, chemically inert, electrolytically active, metallic, and combinations thereof. The coating preferably comprises a titanium thin film or a diamond coating. One of the optical windows preferably comprises an anode and at least one other of the optical windows preferably comprises a cathode. The apparatus preferably further comprises a power supply providing a positive electrical potential to the anode and a negative electrical potential to the cathode. The electrical polarity of the anode and the cathode is preferably reversible. Reversing the polarity preferably cleans a surface of the cathode, preferably by dissolving the scale formation.

The apparatus optionally further comprises an anode which preferably comprises a dimensionally stable anode. In this embodiment the optical windows preferably comprise cathodes. The apparatus preferably further comprises a reversible power supply providing a positive electrical potential to the anode and a negative electrical potential to the cathode.

The present invention is also a method for detecting scale formation, the method comprising: shining an energy beam, preferably comprising infrared energy, through a first optical window, through a fluid stream, and through a second optical window; detecting the intensity of the energy beam; and correlating the intensity with the amount of scale formation on at least one of the optical windows. The method preferably further comprises determining the concentration of carbonate in the fluid stream, preferably by measuring the rate of change of the intensity. The method preferably further comprises activating a control system when a predetermined amount of scale formation is detected. The method optionally comprises any of the steps of alerting an operator, stopping operation of a system, cleaning the system, and/or initiating regeneration of ion exchange resin in a water softening system.

Each of the optical windows preferably comprises a coating, in which case the method preferably comprises applying a positive electrical potential to one of the optical windows and applying a negative electrical potential to the other optical window. Scale on at least one of the optical windows is optionally dissolved, preferably by reversing the polarity of the optical windows or flushing the at least one optical window with an acid.

The method optionally comprises providing an anode, which preferably comprises a third coated optical window or a dimensionally stable anode. The method preferably comprises applying a positive electrical potential to the anode and applying a negative electrical potential to the first and second optical windows. The first and second optical windows are preferably cleaned by applying a negative electrical potential to the anode and applying a positive electrical potential to the first and second optical windows.

The present invention is also a method of detecting scale buildup in an electrolytic cell, the method comprising the steps of shining light on a first electrolytic cell component, reflecting the light from the first component, detecting the reflected light, measuring an intensity of the reflected light, and determining an amount of scale deposited on the first component. The method preferably further comprises the step of initiating an alarm when the scale amount equals a predetermined amount. The wavelength of the light is preferably chosen so that the light is not significantly attenuated during transmission through an electrolyte. The reflecting step is preferably performed near an outlet of the electrolytic cell. The light is preferably reflected from a position at or near an edge of the component. The first component preferably comprises a first electrode, preferably comprising a cathode or an intermediate electrode. The reflecting step preferably comprises diffusely reflecting the light. The light optionally passes through an opening in a second component or an area of the second component transparent to a wavelength of the light. The second component preferably comprises a second electrode, preferably an anode. The shining and detecting steps are optionally performed along substantially a single optical axis.

The present invention is also an apparatus for detecting scale formation in an electrolytic cell, the apparatus comprising a light source for emitting light, a light detector arranged to detect light reflected from a first component of the electrolytic cell, and a processor for determining the amount of scale deposited on the first component based on the measured intensity of the reflected light. The light source, light detector, and processor are preferably incorporated into a single package or housing. The light source preferably transmits light at a wavelength chosen so that the light is not significantly attenuated during transmission through an electrolyte. The light source and light detector are preferably arranged to form a triangle with the location on the first component from which the light is reflected. The light source and the light detector are optionally arranged co-axially with the location on the first component from which the light is reflected. A second component is optionally disposed between the first component and either or both of the light source and the light detector, in which case the second component preferably comprises an electrode comprising an opening or a region transparent to a wavelength of the light. The first component preferably comprises a cathode or an intermediate electrode and the second component preferably comprises an anode.

An object of the present invention is to provide a solid state means of detecting or measuring the rate of carbonate scale formation in an aqueous stream.

Another object of the present invention is that it may be used in any aqueous-containing systems where carbonate formation is detrimental to operation of the system, including but not limited to applications such as electrolytic chlorine cells, other electrolytic devices, boiler water systems, distillers, water softening systems, and membrane systems.

A primary advantage of the present invention is that the detector is solid state and thus can be manufactured at low cost and is small in size.

Another advantage of the present invention is that, unlike conventional systems, it does not require the use of chemical reagents for detecting carbonate in the aqueous stream or for cleaning the carbonate detector.

A further advantage of the present invention is that it may be cleaned by reversing the electrical polarity of the optical windows.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIGS. 1a and 1b are diagrams of an embodiment of the present invention with two optical windows;

FIGS. 2a and 2b are diagrams of an alternative embodiment of the present invention with three optical windows;

FIG. 3 is a diagram showing how an embodiment of the carbonate detector of the present invention may be integrated into an electrolytic cell system;

FIG. 4 is a diagram showing how an embodiment of the carbonate detector of the present invention may be integrated into a water softening system; and

FIG. 5 is a diagram showing an embodiment of the carbonate detector of the present invention that measures the reflectivity of a surface to determine if scale has formed on that surface.

### DETAILED DESCRIPTION OF THE INVENTION

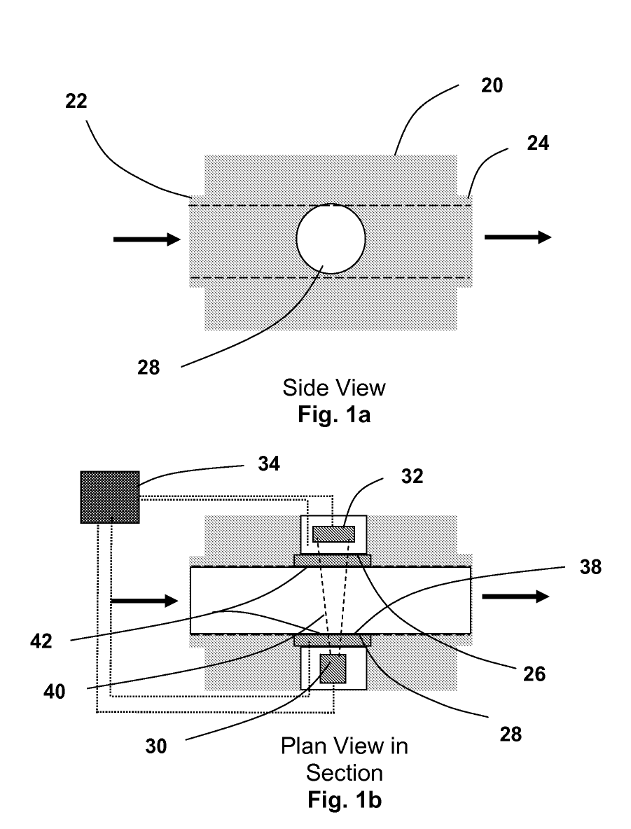

A preferred embodiment of the present invention, depicted in FIGS. 1a and 1b, comprises fluid flow through chamber 20 comprising inlet port 22 and outlet port 24. The fluid optionally comprises electrolyte or one or more oxidants. Optical windows 26 and 28, which are preferably tangent to the fluid flow, allow transmission of energy through the fluid flowing within chamber 20. Optical windows 26 and 28 are sealed to or disposed on chamber 20 and fluid flowing within chamber 20 is in wetted contact with the inside surface of optical windows 26 and 28. Optical windows 26, 28 preferably comprise, quartz, synthetic sapphire, or any other material compatible with the aqueous fluid. Quartz and synthetic sapphire have excellent chemical resistance to high chlorine concentrations.

In the preferred embodiment, energy emitting device 30, comprising for example an infrared emitter such as an LED, shines energy beam 40 through optical window 28, then through the aqueous solution, and finally through opposing optical window 26 and on to energy receiving device 32, preferably an infrared phototransistor. An electrical signal generated by energy receiving device 32 is preferably transmitted to control board or system 34. The intensity of energy received at energy receiving device 32 preferably determines whether control board 34 activates a switch for ultimate transmission to the system to be controlled. As carbonate or other contamination accumulates on the wetted surface of optical windows 26, 28 the transmission of energy through them is obscured. The reduction in energy transmission can be used as an indicator to determine that carbonate as a contaminant is present in the fluid stream. Control board 34 preferably comprises a circuit or other means for quantifying the level of scale both on optical windows 26, 28 and in the fluid stream.

The rate of degradation of the optical path due to blockage of either or both optical windows 26, 28, i.e. the rate of carbonate formation or deposition, is correlated with the concentration of carbonate in the aqueous fluid. In this way, the concentration of carbonate in the aqueous path is determined. This is useful information for water quality analysis or when the present apparatus is used as a fluid quality indicator.

In a preferred embodiment of the present invention, anode optical window 26 is preferably coated with film 42, which preferably comprises diamond or alternatively a thin metal layer comprising, for example but not limited to, titanium. Film 42 is preferably applied by chemical vapor deposition, sputtering, physical vapor deposition, evaporation, or any other method known in the art for depositing a film on a substrate. Anode optical window 26 is located within the fluid stream flowing within chamber 20 and is opposite optical window 28, which acts as a cathode. Optical window 28 is also preferably coated with film 42 (preferably diamond). The films (preferably diamond) preferably are electrically conductive, optically transparent, electrolytically active, and/or have excellent chemical resistance or are chemically inert. Diamond has excellent chemical resistance to a wide variety of chemicals.

A power supply preferably applies a positive direct current electrical potential to film 42 on anode optical window 26 and a negative electrical potential to film 42 deposited on cathode optical window 28. The potentials may optionally be reversed. Total dissolved solids (TDS) within the fluid solution flowing within chamber 20 provide the electrical conduction path between film 42 on anode optical window 26 and film 42 on cathode optical window 28. The applied current creates an electrolytic reaction, thus facilitating carbonate formation on optical window 28. High pH conditions at film 42 deposited on cathode optical window 28 attracts carbonate from the fluid solution to deposit carbonate film 38 on cathode optical window 28.

Carbonate scale typically forms on the cathode element of an electrolytic cell which is associated with high pH conditions. This feature is utilized to generate a high pH condition on cathode optical window 28 in order to accelerate the deposition of carbonate scale. With a negative charge applied to the titanium metal or diamond deposited on cathode optical window 28, it acts as a cathode for attraction of carbonate that may be in the fluid stream. As carbonate scale forms on cathode optical window 28, energy transmission, preferably infrared, is blocked. The loss of energy transmission due to carbonate blockage is detected, indicating not only that carbonate formation is evident within the detector, but more importantly that carbonate is present in the fluid-containing system.

In the preferred embodiment of the present invention, the carbonate detection apparatus can be cleaned by reversing the polarity of the anode and cathode in the detector. This method for scale removal is described in U.S. Pat. No. 4,088,550 to Malkin, entitled “Periodic Removal of Cathodic Deposits by Intermittent Reversal of the Polarity of the Cathodes”, incorporated herein by reference. In this way, the cathodes are now the anode, and the low pH condition at the anode removes the carbonate scale. In an alternative embodiment, the carbonate detector, particularly the cathode, can be easily cleaned of carbonate scale by flushing the device with an appropriate acid such as hydrochloric acid, acetic acid (vinegar) or other suitable compositions. For the device described herein, carbonate film 38 on optical window 28 is preferably cleaned by reversing the electrical polarity of film 42 on anode optical window 26 and film 42 on cathode optical window 28. In this manner, a low pH condition is established at cathode optical window 28 (now acting as the anode), which dissolves the carbonate formation.

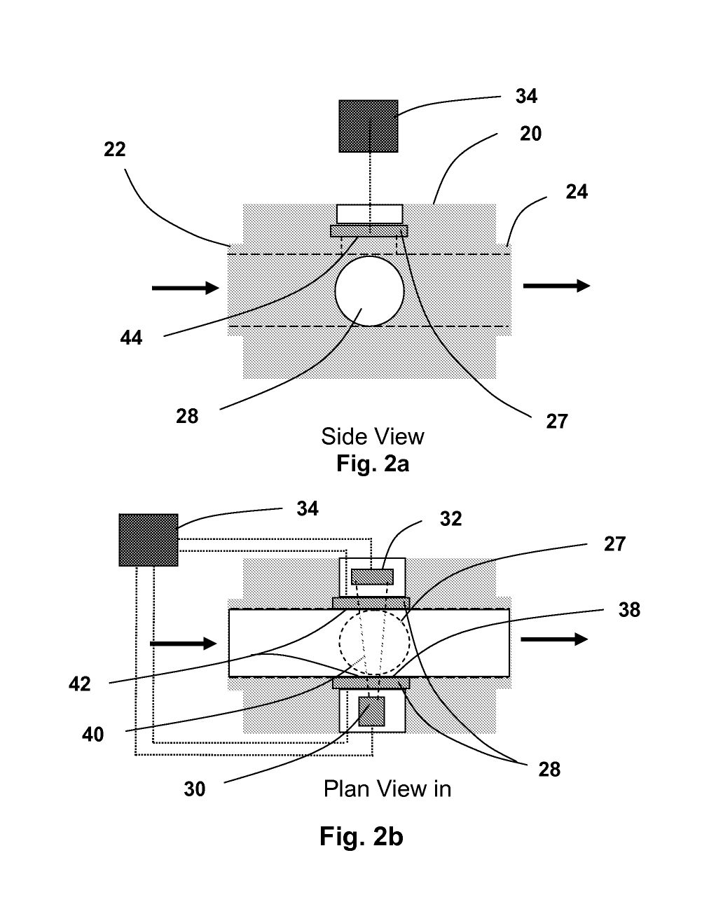

An alternative embodiment of the present invention for facilitating scale formation is shown in FIGS. 2a and 2b. Optical windows 28 allow transmission of energy through the fluid flowing within chamber 20. Optical windows 28 are sealed to chamber 20 and fluid flowing within chamber 20 is in wetted contact with the inside surface of optical windows 28. Energy emitting device 30, for example an infrared emitter LED, shines energy beam 40 through optical window 28, then through the aqueous solution, and finally through opposing optical window 28 and on to energy receiving device 32.

In this alternative embodiment of the present invention, a third window, anode optical window 27, is preferably coated with film 44 (preferably diamond). Film 44 is preferably applied by chemical vapor deposition or a similar method. Anode optical window 27 is located within the fluid stream flowing within chamber 20 and is preferably adjacent to or nearby optical windows 28, which in this embodiment both act as cathodes. Optical windows 28 are preferably coated with films 42 (preferably diamond). A positive direct current electrical potential is applied to film 44 on anode optical window 27 and negative electrical potential is applied to films 42 deposited on optical windows 28. Total dissolved solids (TDS) ore electrolyte within the fluid solution flowing within chamber 20 provide the electrical conduction path between film 44 on anode optical window 27 and films 42 on optical windows 28. The applied current creates an electrolytic reaction. High pH conditions at film 42 acting as the cathode attracts carbonate from the fluid solution to deposit carbonate film 38 on optical windows 28.

Anode optical window 27 may alternatively be replaced by a dimensionally stable anode. Dimensionally stable anodes are described in U.S. Pat. No. 3,234,110 to Beer, entitled “Electrode and Method of Making Same,” incorporated herein by reference, whereby a noble metal coating is applied over a titanium substrate. The dimensionally stable anode is preferably coated with diamond, since it is known in the art that diamond coated electrodes offer significant improvements in durability over conventional dimensionally stable anodes.

In any of the above embodiments, the electrical signal from energy receiving device 32 is preferably received at control board 34, which preferably comprises a processor or computer. The electrical signal received at control board 34, which is preferably correlated to the intensity of energy detected by energy receiving device 32, is preferably an analog signal, although it can be a digital signal. As the energy intensity detected by energy receiving device 32 decreases to a prescribed value, which preferably indicates that a substantial amount of carbonate has formed on cathode optical window 28, control board 34 preferably closes or activates a switch or relay which preferably sends a signal to the system control device to either shut down the equipment or notify the operator, preferably via an alarm, that maintenance is required to mitigate the effects of carbonate in the system. Thus operation of the equipment may be shut down or controlled to prevent carbonate in the fluid stream from damaging the equipment.

The switch closure set point can be adjusted to match the specific application. For example, a switch closure to indicate that a water softener ion exchange resin column has been saturated may be set at a very low threshold. In an electrolytic cell application, the switch threshold may be set at a higher value. In addition, the detection sensitivity of the control system is preferably adjustable. Some level of carbonate formation in the electrolytic cell may not be damaging, but a continued buildup of carbonate in the electrolytic cell will bridge the gap between anode and cathode electrodes in the electrolytic cell and begin to damage the electrolytic cell.

Control board 34 preferably evaluates the rate of carbonate buildup on cathode optical window 28 over time. The rate of carbonate buildup can be correlated to the concentration of carbonate in the aqueous fluid stream. This information is useful for fluid quality analysis or determining the effectiveness of carbonate removal systems.

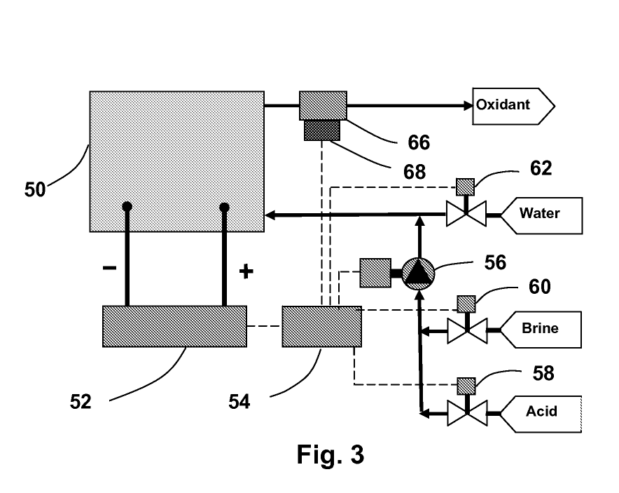

FIG. 3 depicts the carbonate detector of the present invention integrated into an electrolytic cell system. Electrolytic cell 50 preferably uses dimensionally stable anodes and cathodes to convert a dilute brine solution to chlorine-based aqueous oxidants which are used to disinfect drinking water, or wastewater for cooling towers, swimming pools, and other applications requiring a chlorine or mixed oxidant disinfectant. Power to the electrodes in electrolytic cell 50 is provided by power supply 52. Water, preferably softened, is applied to electrolytic cell 50 via valve 62. Concentrated brine is fed to electrolytic cell 50 via valve 60 and is preferably metered to electrolytic cell 50 via brine pump 56. The system is preferably controlled by electrolytic cell controller 54.

Calcium as a contaminant can enter electrolytic cell 50 via the water or the brine source. Prior to entrance to electrolytic cell 50, calcium contaminants in the water source are preferably removed with an ion exchange softener or membrane softening system. However, the quality of salt used to generate the concentrated brine source varies from location to location. Brine is the primary source of calcium contaminant within electrolytic cell 50. Due to the concentration of sodium chloride in concentrated brine, neither an ion exchange softener nor a membrane softening system can effectively remove calcium contaminants from the brine solution. Because the quality of salt varies by application, the rate of carbonate formation within electrolytic cell 50 is indeterminate. As carbonate forms on electrodes within electrolytic cell 50, carbonate also forms within carbonate detector 66. When a preset value of carbonate within carbonate detector 66 is reached, carbonate detector controller 68 preferably activates a relay which preferably sends an electrical signal to electrolytic cell controller 54.

During operation of electrolytic cell 50, two phase flow in the oxidant discharge stream can create instability within energy receiving device 32 (FIG. 1). To mitigate the instability, measurement of carbonate formation can occur during the shutdown sequence from operation of electrolytic cell 50. During the shutdown sequence, power supply 52 is de-activated while water continues to flow by virtue of valve 62 remaining in the open position during the evaluation sequence of carbonate detector 66. If carbonate contamination reaches a threshold value in carbonate detector 66, carbonate detector controller 68 sends the appropriate electrical signal to electrolytic cell controller 54. Electrolytic cell controller 54 then completes the shutdown sequence of electrolytic cell 50 by closing electric valve 62. In the preferred embodiment, electrolytic cell controller 54 then activates a cleaning cycle. A preferred cleaning cycle begins by opening electric valve 58. Brine pump 56 is then activated to pump acid solution through electrolytic cell 50, out the discharge port of electrolytic cell 50 and through carbonate detector 66, thereby cleaning carbonate detector 66 and electrolytic cell 50. After the cleaning cycle is completed, electric valve 62 can be opened to purge electrolytic cell 50 with water. Carbonate detector 66 can then be activated to verify that the system is clean. Because carbonate detector 66 is downstream from electrolytic cell 50, carbonate detector 66 should be the last item cleaned.

Alternatively, carbonate detector 66 activates the relay in carbonate detector controller 68 which then sends a control signal to electrolytic cell controller 54. Electrolytic cell controller 54 then sends an alarm signal to notify the operator that maintenance is required, rather than activating an automatic acid washing sequence.

The monitoring, control, and cleaning sequence described herein can be applied to a variety of systems that are subject to carbonate contamination. For instance, a boiler or distiller water system can be monitored and alarmed in the same fashion. However, an acid washing cycle may not be the preferred cleaning sequence. To clean carbonate detector 66, carbonate detector controller 68 may alternatively reverse the polarity of the anode optical window 26 and cathode optical window 28 (FIG. 1) either by manual or automatic means, thereby cleaning carbonate from cathode optical window 28. Normal operation of carbonate detector 66 can then proceed. Similarly, the polarity of power supply 52 may be reversed in order to clean the cathode of electrolytic cell 50.

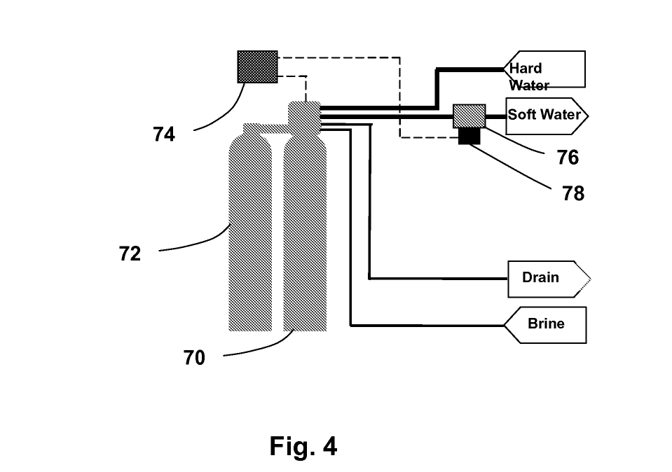

In the embodiment of the present invention depicted in FIG. 4, carbonate detector 76 acts as a signaling device for regeneration of an ion exchange softening system. The ion exchange softening system comprises primary ion exchange tank 70, secondary ion exchange tank 72, and ion exchange controller 74. As the ion exchange resin in primary ion exchange tank 70 becomes saturated with calcium carbonate, the ion exchange resin can no longer attract calcium carbonate in the water stream. Carbonate then begins to form in carbonate detector 76. A signal in carbonate detector controller 78 activates a relay which is then transmitted to ion exchange controller 74. Ion exchange controller 74 then activates the regeneration cycle. In the regeneration cycle, water flow is diverted to secondary ion exchange tank 72 and primary ion exchange tank 70 is placed in the backwash cycle where the resin is purged of calcium, and the ion exchange resin is re-loaded with sodium. The cycle is repeated when secondary ion exchange tank 72 becomes saturated with calcium carbonate. Since acid cleaning cannot be utilized in this system, carbonate detector 76 is cleaned simultaneously when ion exchange controller 74 places the ion exchange system in regeneration. Carbonate detector 76 is cleaned preferably when carbonate detector controller 78 reverses polarity on the anode and cathode windows in carbonate detector 76.

### Detection of Scale on Electrodes or Other Surfaces

Typically, periodic table column II divalent cations Ca²⁺, Mg²⁺, Ba²⁺, and Sr²⁺ found in water are what give rise to scaling once their solubility limit in solution is exceeded. Certain scaling (CaCO₃ for instance) which occurs on an electrode or other surface can be removed using an acid wash. However, hard scaling (e.g. BaSO₄) is extremely resistant to chemical and mechanical removal. It is advantageous to detect scaling on electrodes before its accumulation results in permanent damage of the electrolytic cell.

One embodiment of such a detector preferably comprises a light source directed onto a cell electrode and a light-receiving sensor that captures light from the light source that has been either reflected off the electrode or transmitted through the electrode. The detector preferably determines the presence and/or absence of scaling buildup on a cell electrode and changes in the amount of scaling buildup on a cell electrode. The detector output is preferably proportional to the electrode reflectivity or, alternatively, transmissivity. The accumulation of scaling on an electrode typically greatly modifies the electrode's optical reflecting and transmission characteristics. The detector may optionally detect electrode color and texture.

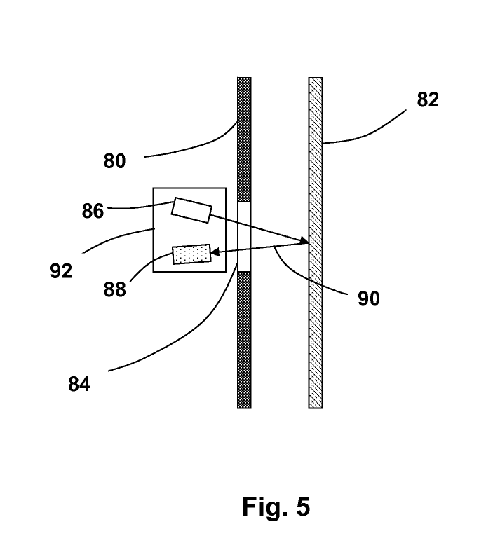

Referring to FIG. 5, transmitter light source 86 may comprise any type, including but not limited to a bright lamp, a light emitting diode (LED), or a laser. Light receiving sensor 88 may also comprise any type, including but not limited to a phototransistor, a photoresistor, an integrated light-to-digital signal sensor, or an integrated light-to-analog signal sensor. The integrated sensors may be combined in integrated circuit package 92 with associated electronic circuitry as well as optical filtering. Electrical circuitry comprising current-to-voltage circuitry, signal conditioning circuitry, analog-to-digital circuitry, and/or alarm circuitry may be employed. Optical components used may include a light source focussing lens, a light-receiving sensor focussing lens, a light source wavelength filter, a light-receiving sensor wavelength filter, a light source optical polarizer, and/or a light-receiving sensor optical polarizer. Transmitter light source 86, light receiving sensor 88, their associated integrated circuit package 92, any associated electronics, and any associated optical components are preferably incorporated into a single protective package or housing, which preferably maximizes noise immunity.

The light source wavelength or wavelength range is preferably chosen so that light 90 is not absorbed over the distance traveled to light receiving sensor 88 in liquid water, brine or other electrolyte solution being used to such an extent that light receiving sensor 88 cannot detect the presence/absence of scaling buildup on a cell electrode 82 and/or detect changes in the amount of scaling buildup on cell electrode 82. The spectral sensitivity of light receiving sensor 88 is preferably matched to that of the light source wavelength in order to maximize detector sensitivity.

Light receiving sensor 88 and light source 86 are preferably located near the cell outlet position, as this location typically accumulates a greater amount of scaling, and are preferably located at or near an electrode edge. However, light receiving sensor 88 and light source 86 can be located near electrode 82 anywhere scaling buildup occurs on electrode 82. Light receiving sensor 88 and light source 86 preferably have converging optical axes which intersect at the surface of electrode 82. This preferably puts them in a triangular configuration where they form the base of the triangle and electrode 82 is located at the vertex. In this configuration, light 90 from light source 86 is diffusely reflected from electrode 82.

As shown in FIG. 5, light source 86 and/or light receiving sensor 88 may optionally be located so that light 90 is transmitted through opening 84 in electrode 80 (typically a primary anode), reflected off electrode 82 (typically either a primary cathode or an intermediate electrode), and returned through opening 84 to light receiving sensor 88. This configuration be an add-on or retrofitted to any electrolytic cell currently in use. Opening 84 may optionally comprise a transparent section of electrode 80. The light receiving sensor and light source may alternatively be linearly configured to share a single optical axis. In this configuration, light from the light source is preferably transmitted through an open or transparent section of a first electrode, and the light receiving sensor is preferably either aligned with this section or incorporated into the transparent section.

Light source 90 is preferably located at a distance from electrode 82 which maximizes the signal at light receiving sensor 88, and light receiving sensor 88 is preferably located at a distance from electrode 82 which maximizes signal output.

According to the present invention, multiple detectors placed strategically may optionally be employed.

Although the invention has been described in particular as to carbonate and carbonate scale detection, the invention is useful for detecting other components or contaminants and the term “scale” is used herein to describe all such materials and deposits. Similarly, as used throughout the specification and claims, “light” means any electromagnetic radiation.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A method of detecting scale buildup in an electrolytic cell, the method comprising the steps of:
shining light on a first electrolytic cell component;
reflecting the light from the first component;
detecting the reflected light;
measuring an intensity of the reflected light; and
determining an amount of scale deposited on the first component.

2. The method of claim 1 further comprising the step of initiating an alarm when the scale amount equals a predetermined amount.

3. The method of claim 1 wherein a wavelength of the light is chosen so that the light is not significantly attenuated during transmission through an electrolyte.

4. The method of claim 1 wherein the reflecting step is performed near an outlet of the electrolytic cell.

5. The method of claim 1 wherein light is reflected from a position at or near an edge of the component.

6. The method of claim 1 wherein the first component comprises a first electrode.

7. The method of claim 6 wherein the first electrode comprises a cathode or an intermediate electrode.

8. The method of claim 1 wherein the reflecting step comprises diffusely reflecting the light.

9. The method of claim 1 wherein the light passes through an opening in a second component or an area of the second component transparent to a wavelength of the light.

10. The method of claim 9 wherein the second component comprises a second electrode.

11. The method of claim 10 wherein the second electrode comprises an anode.

12. The method of claim 1 wherein the shining and detecting steps are performed along substantially a single optical axis.

13. An apparatus for detecting scale formation in an electrolytic cell, the apparatus comprising:
a light source for emitting light;
a light detector arranged to detect light reflected from a first component of said electrolytic cell; and
a processor for determining an amount of scale deposited on said first component based on a measured intensity of the reflected light.

14. The apparatus of claim 13 wherein said light source, said light detector, and said processor are incorporated into a single package or housing.

15. The apparatus of claim 13 wherein said light source transmits light at a wavelength chosen so that the light is not significantly attenuated during transmission through an electrolyte.

16. The apparatus of claim 13 wherein said light source and said light detector are arranged to form a triangle with a location on said first component from which the light is reflected.

17. The apparatus of claim 13 wherein said light source and said light detector are arranged co-axially with a location on said first component from which the light is reflected.

18. The apparatus of claim 13 wherein a second component is disposed between said first component and either or both of said light source and said light detector.

19. The apparatus of claim 18 wherein said second component comprises an electrode comprising an opening or a region transparent to a wavelength of said light.

20. The apparatus of claim 18 wherein said first component comprises a cathode or an intermediate electrode and said second component comprises an anode.
